(19) United States
(12) Patent Application Publication
(10) Pub. No.: US 2009/0060327 A1
(43) Pub. Date: Mar. 5, 2009

(54) Image and Video Enhancement Algorithms

(75) Inventor: Tai-Wu Chiang, Aloha, OR (US)

Correspondence Address: Venture Pacific Law, PC, 5201 Great America Parkway, Suite 270, Santa Clara, CA, 95054, US

(73) Assignee: INJINNIX, INC., Fremont, CA (US)

(21) Appl. No.: 11/846,497

(22) Filed: Aug. 28, 2007

(51) Int. Cl. G06K 9/00; G06K 9/40

(52) U.S. Cl. 382/168; 382/260

(57) ABSTRACT

Ever since the advent of histogram equalization algorithms (“HE”) for image enhancements, there has been numerous variants of HE been proposed to improve or overcome the problems of the traditional HE. One of the drawbacks of the traditional HE is that the amount of enhancement is not adjustable. This invention gives a simple and efficient method to generalize the traditional HE to become a variable histogram equalization (“VHE”) by a single parameter, Q. Q ranges from 0 to 1 such that when Q equals 0, there is no enhancement and when Q reaches 1, the enhancement of VHE becomes the same as that of traditional HE. Therefore, the amount of image enhancement can be controlled by changing the parameter Q to achieve better visually appealing image enhancements.

### FIELD OF INVENTION

The present invention relates to image processing, and, in particular, to digital processing, including histogram processing.

### BACKGROUND

Ever since the advent of histogram equalization (“HE”) algorithm for image enhancements, there has been numerous variants of HE been proposed to improve or overcome the problems of the traditional HE. One of the drawbacks of the traditional HE is that the amount of enhancement is not adjustable. It would be desirable to have an invention that provides a simple and efficient method to generalize the traditional HE to become a variable histogram equalization (“VHE”) by a single parameter Q ranges from 0 to 1 in a way when Q equals 0, there is no enhancement and when Q reaches 1, the enhancement of VHE becomes the same as that of traditional HE. Therefore the amount of image enhancement can be controlled by changing the parameter Q to achieve better visually appealing image enhancements.

### SUMMARY OF THE INVENTION

An object of the present invention is to provide a single designated parameter in the adjustment of an enhanced image.

Another object of the present invention is to provide methods for adjusting color saturation of a digital image.

Yet another object of the present invention is to provide methods for improving the dynamic range enhancement of variable histogram equalization by adding a gamma compensation stage.

Still another object of the present invention is to provide methods for automatic searching of the optimal parameters for best visually appealing image/video enhancement.

Briefly, the present invention discloses a method for calculating an enhanced image of a digital image wherein the digital image having a plurality of pixels each have a plurality of color components, comprising the steps of: generating a histogram for each color components of a digital image; summing the histograms to generate a combined histogram; calculating a modified histogram as a function of a designated parameter; generating a remapping curve as a function of the modified histogram by a cumulative distribution function; and calculating enhanced pixels for an enhanced image.

An advantage of the present invention is that it provides a single designated parameter in the adjustment of an enhanced image.

Another advantage of the present invention is that it provides methods for adjusting color saturation of a digital image.

Yet another advantage of the present invention is that it provides methods for improving the dynamic range enhancement of variable histogram equalization by adding a gamma compensation stage.

Still another advantage of the present invention is that it provides methods for automatic searching of the optimal parameters for best visually appealing image/video enhancement.

### DESCRIPTION OF THE DRAWINGS

The following are further descriptions of the invention with reference to figures and examples of their applications.

FIG. 1 is a flowchart illustrating steps in calculating for variable histograms;

FIG. 2 illustrates relationship between Q, Q1 and P based on a given ratio R;

FIG. 3 is a flowchart illustrating steps in calculating for variable histograms and GCS;

FIG. 4 is a flowchart illustrating steps in calculating automatic searching algorithm for gamma compensated variable histogram equalization;

FIG. 5 illustrates an example of a monotonically increasing weight function;

FIG. 6 illustrates an example of a monotonically decreasing weight function;

FIG. 7 illustrates an example of a bell shape weight function; and

FIG. 8 illustrates an example of a rectangular weight function.

### DETAILED DESCRIPTION OF THE PREFERRED EMBODIMENTS

### Part I: Variable Histogram Equalization for Image and Video Light Compensation

One aspect of this invention is intended to enhance luminous and/or dynamic ranges and/or tonal range and/or contrast ratio and/or color saturation of under-exposed pictures/images and videos which may be captured at ill-lighting conditions or with scenes composed of strong contrast of bright and dark areas/objects, and is especially useful for digital still cameras, camera phones and video surveillances.

Histogram Equalization (HE) is widely used as a means to enhance contrast of an image or video frames. However HE does not always produce the right amount of enhancement that viewers desired. Most often, HE stretch contrast too much that causes un-natural looking of the altered images. This invention intends to give a more regulated and adjustable enhancement through a single designated parameter, named Q.

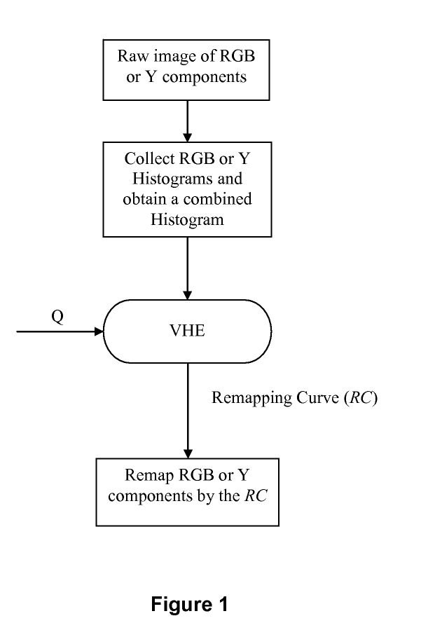

To facilitate the idea of adjusting the amount of the traditional HE enhancement, the traditional HE is generalized to become a variable HE (“VHE”). FIG. 1 illustrates the general steps of an embodiment of the present invention. First, histograms are calculated by counting frequencies of each pixel's red, green and blue color intensities in an image or the luma component (of YCbCr) of a video frame. Then, these histograms are summed to produce a combined histogram. A proper normalization is done on this combined histogram to account for varying image or video frame sizes. Let's denote the said Histogram as function H(i), i=0 . . . 255 of gray levels, where i is the gray scale intensity level for 8-bit pixel depth images. For other number of bits depth image format, the range of i can be adjusted accordingly. For example, for a 12 bit pixel depth, the range of i is from 0 to 2¹²−1. A modified histogram (“MH”) is then calculated as:

MH(i)=power(H(i), Q), where power function is to raise each H(i) to the power of Q, where Q is a fractional number between 0.0 and a constant C inclusive, i.e., 0.0<=Q<=C, where C is a positive number. In the normal case, C=1.0

After the MH is calculated, then a cumulative distribution function (“CDF”) is applied to the MH(i), instead of the original histogram H(i), to generate a remapping curve denoted as RC(j). A proper rounding and normalization to the remapping curve RC(j) is done to ensure that it remaps to integers and within the range of 0 to 255 inclusive for an 8-bit pixel depth. In one embodiment, the cumulative distribution function can be as follows:

$$CDF ( j ) • {\sum }_{i = 0}^{j} MH ( i ) , 0 \leq j \leq 255.$$

The following equations (1) (or use equation 1P for video) and (2) summarize the operations to obtain the remapping curve RC(j):

H(i)=(HR(i)+HG(i)+HB(i))×k, 0≦i≦255, k>0, for images (1)

or

H(i)=HY(i)×k, 0≦i≦255, k>0, for videos (1P)

where HR(i), HG(i) and HB(i) are histograms for red, green and blue color components (RGB), respectively, of pixels of an image, and HY(i) is the histogram of luminous component (YCbCr) of pixels of a video frame, and k is the normalization constant.

$$RC ( j ) = round ( p \times {\sum }_{i = 0}^{j} {H ( i )}^{Q} ) ,$$

0≦j≦255, 0≦Q≦C, C>0 (2)

where p is a normalization factor such that after rounding by the round( ) function, the range of RC(j) is in integers of [0, 255] for 8-bit depth images or videos.

After the remapping curve RC is successfully obtained, the following procedures describe how to obtain the enhanced version of images and videos:

For each pixel p in an image, let's use pr, pg and pb to represent the red, green and blue components of the pixel. The maximum of the three components is denoted by l=max(pr, pg, pb). Then the enhanced pixel p′ whose 3 components p′r, p′g and p′b are obtained by the following equations:

l′=RC(l)

$$f = \frac{{l}^{′}}{l}$$

p′r=a₁×f×pr for image RGB color space

p′g=a₂×f×pg

p′b=a₃×f×pb

or, by equations:

$$f = \frac{RC ( py )}{py}$$

p′y=a₁×RC(py)

p′u=a₂×f×pu for video YUV color space

p′v=a₃×f×pv

where the proportional coefficients a₁, a₂, a₃ are for tuning purpose. In most cases, they are all ones but they can be any numbers and also can be functions of the pixel's position and its RGB components.

An optional procedure for adjusting color saturation can be added in the following way:

l′=RC(l)

$$f = \frac{{l}^{′}}{l}$$

p′r=a×f×pr+(1−a)×RC(pr)

p′g=a×f×pg+(1−a)×RC(pg)

p′b=a×f×pb+(1−a)×RC(pb)

where the parameter a is a fractional number between 0 and 1. When the parameter a is set to 1, it is for maximum color saturation and 0 for minimum color saturation, respectively. This parameter is used to adjust the enhancement of color saturation of RGB color format images.

For videos, the procedure for adjusting color saturation is similarly done by the following equations:

$$f = \frac{RC ( py )}{py}$$

p′y=RC(py)

p′u=(a×f+1−a)×pu

p′v=(a×f+1−a)×pv

where the parameter a is a fractional number between 0 and 1. When the parameter a is set to 1, it is for maximum color saturation and 0 for minimum color saturation, respectively.

For videos, for each pixel p in a video frame, let's use py, pu and pv to represent the luma (Y), chroma Cb and Cr components of the pixel, respectively. Then the enhanced pixel p′ whose 3 components p′y, p′u and p′v are obtained by the following equations:

p′y=a₁×RC(py)

p′u=a₂×pu

p′v=a₃×pv

where the proportional coefficients a₁, a₂, a₃ are for tuning purpose. In some cases, they are all ones but they can be any numbers and also can be functions of the pixel's position and its YCbCr components.

For other color space representations other than RGB and YCbCr, similar procedures can be derived from above equations.

### Part II: Gamma Compensated Variable Histogram Equalization for Image and Video Light Compensation

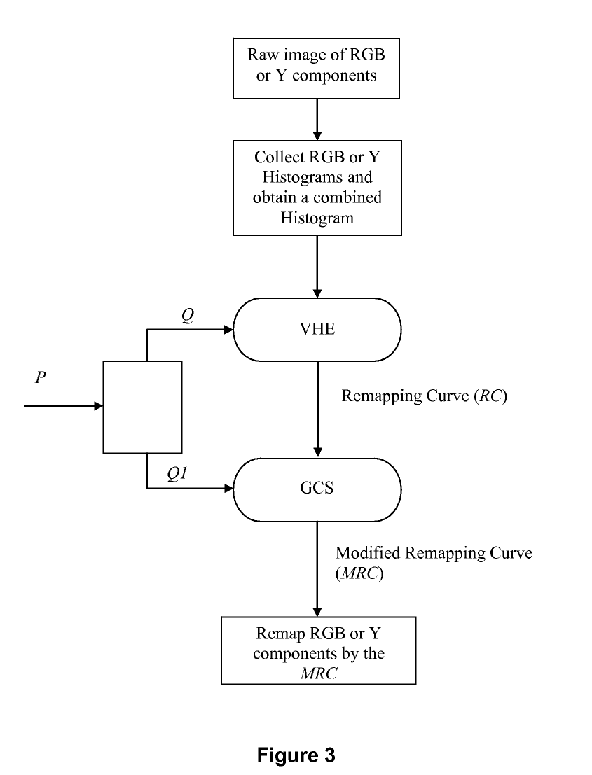

To further improve the dynamic range enhancement of VHE, a gamma compensation stage (“GCS”) may be combined to the output of VHE. Here, the issue of how to balance the compensation strengths between VHE and GCS to achieve optimally visually appealing image enhancement is addressed. FIG. 3 illustrates the general steps of an embodiment of this present invention.

The gamma operation operates on the remapping curve RC obtained from description of Part I. This is different from the usual sense of gamma operation which operates on pixels of an image. The output of this gamma operation is a modified remapping curve (“MRC”), which may be defined as follows:

MRC(i)=floor(power(RC(i)/255,Q1)*255), i=0 . . . 255,

where the floor function rounds numbers to its nearest integer toward minus infinity, and Q1 is a fractional number between 0.0 and C, i.e., 0.0<=Q1<=C, where C is a positive number identical in value as defined in Part I, equation (2).

This Modified Remapping Curve MRC may replace the original remapping curve RC in Part I to be used to produce the enhanced images as described above.

In many cases, it is desirable to have a single adjusting parameter instead of two independent parameters Q and Q1 for adjusting image enhancement. Therefore, the following describe how to use a single parameter P to adjust both Q and Q1.

Let's first find the medium MED of a Histogram H by the following equation:

$$MED = \frac{{\sum }_{i = 0}^{255} i \times H ( i )}{{\sum }_{i = 0}^{255} H ( i )} ,$$

and then we first define a threshold th of a Histogram H:

$$th = \frac{{\sum }_{i = 0}^{255} H ( i )}{255 * a} ,$$

where a is a constant that we may set to 1.5 normally, but it can be adjusted according to different types of image contents.

Then the tonal range (“TR”) of a histogram H is defined as

$$T R = {\sum }_{i = 0}^{255} F ( i ) , \\ where$$

$$F ( i ) = \{ \begin{matrix}1 , H ( i ) \geq th \\ 0 , H ( i ) < th\end{matrix}$$

Then a ratio R is defined as

$$R = \frac{T R}{MED} \times α ,$$

where α=0.4 in our normal case but it can be changed according to types of image contents.

After we have computed R, then we can use a single parameter P to obtain both Q and Q1 by the following equations:

Q=a×tan(b×P)

Q1=1−c×log(R×tan(d×P)+1) (3)

where a, b, c, d are constants. In normal cases, they are 0.4, 0.6, 0.4 and 0.75 respectively. However, they can be adjusted according to types of image contents.

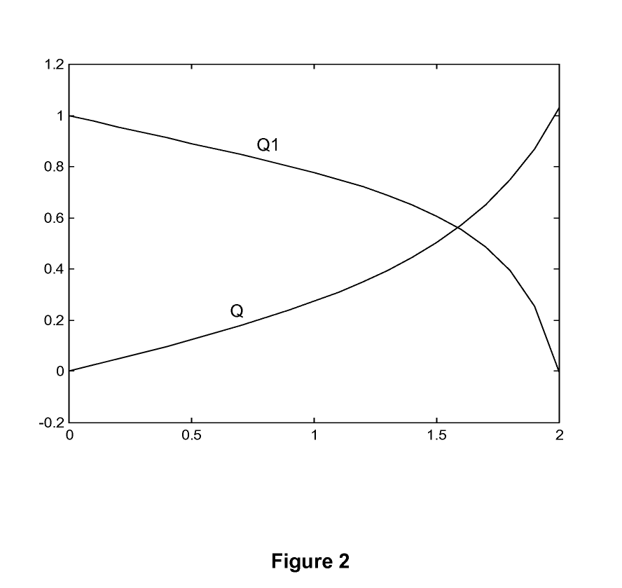

The parameter P for equation (3) is the main enhancement control that in the range of 0.0 to 2.0. The key point for equation (3) is that when P is increasing, Q should be monotonically increasing too but Q1 should be at the same time monotonically decreasing. The ratio R is to control how fast Q1 is to decrease. The higher the R, the faster the Q1 decreases. See FIG. 2 for an example where R=0.8.

### Part III: Automatic Searching Algorithm for Gamma Compensated Variable Histogram Equalization for Image and Video Light Compensation

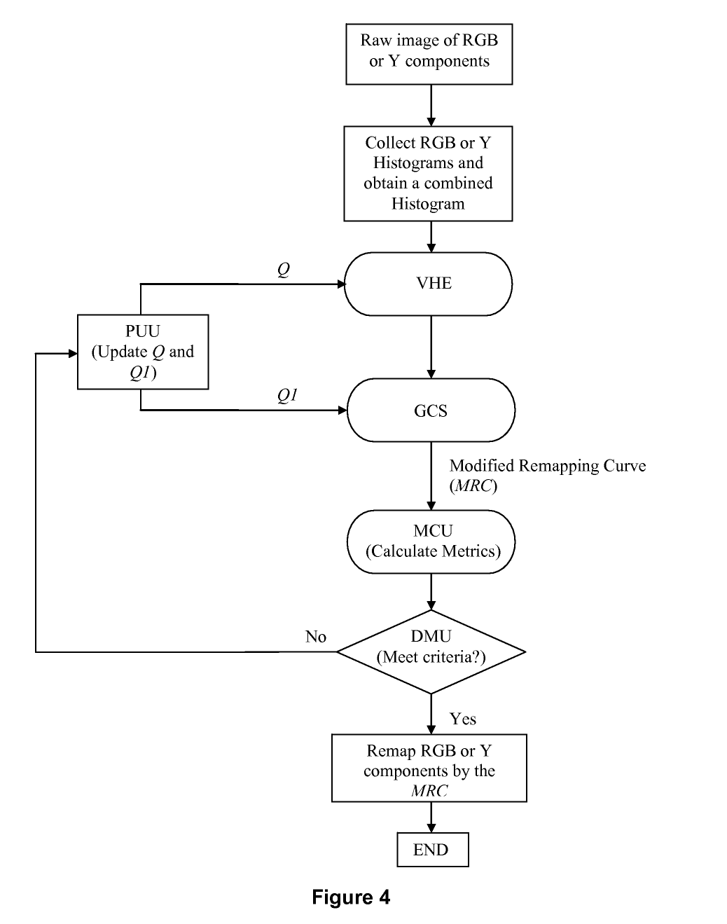

The automatic searching algorithm may be used to automatically find the optimal value of Q and Q1 (or P) for best visually appealing image/video enhancement. The basic idea is to iteratively updating Q and Q1 (or P) from initial values until a certain number of specific metrics, defined by weighted summations of the altered histogram (“AH”), against a set of criteria are met. The algorithm is derived from gamma compensated variable histogram equalization (Part II). In addition to the original functional units, it adds three more functional units: (1) a metric calculation unit (“MCU”) to generate a set of metrics based on the altered histogram which in term can be calculated by the MRC; (2) a decision making unit (“DMU”) that determines if the enhancements have been achieved or not based on the generated metrics from MCU and to compare the metrics against a set of empirical rules; and (3) a parameter updating unit (“PUU”) to generate new values for parameters Q and Q1 for VHE and GCS, respectively, if DMU decides it needs to loop further. Please see FIG. 4 for a flowchart of the processing steps.

After CGS (as explained in Part II), a MRC is generated, and, based on this MRC an altered histogram is generated. AH can be generated through applying MRC to remap all the pixels in the image or video frame and then calculate the histogram again for this enhanced image or video. However a faster way to calculate AH without counting through all pixels is through the original histogram H(i) by:

AH(MRC(i))=AH(MRC(i))+H(i)

for each i=0 to 255, in which each AH(i) was initially zeroed.

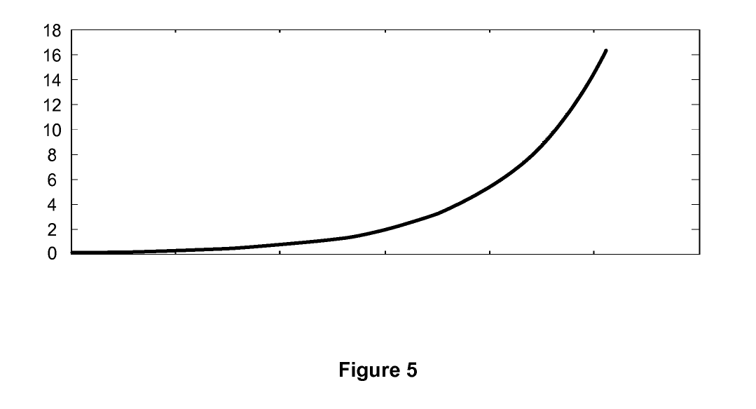

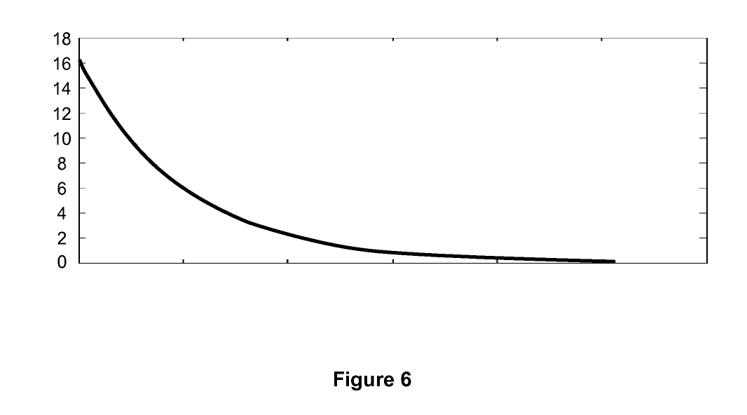

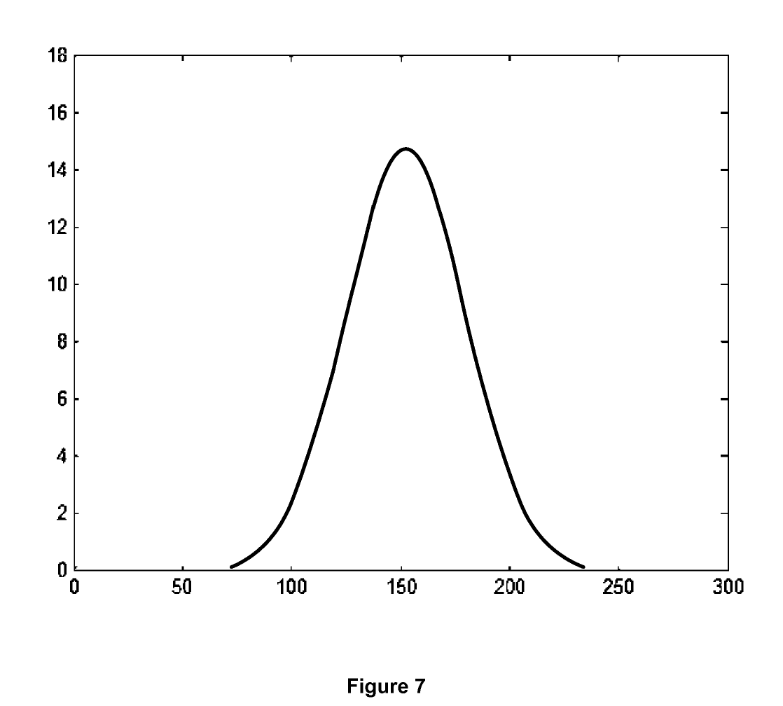

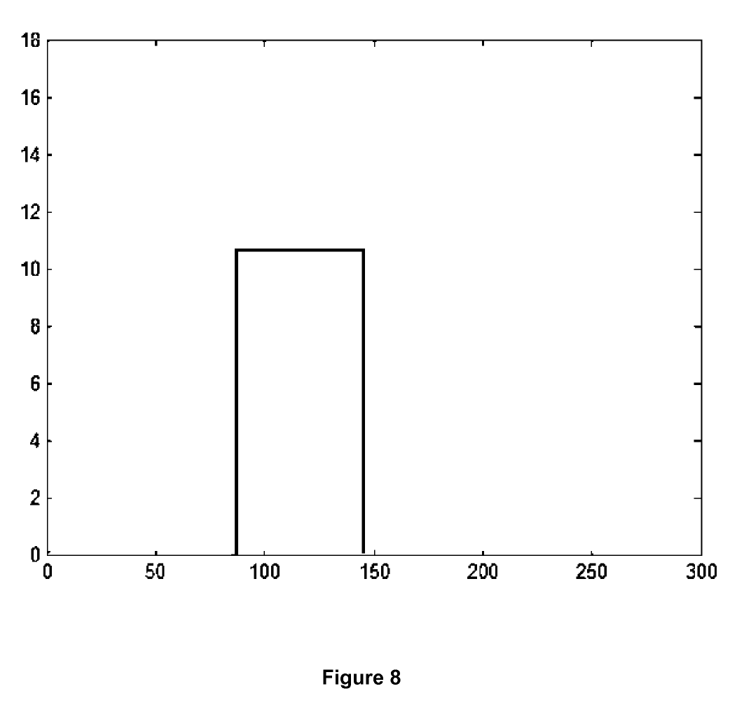

AH serves as the foundation for giving information about how much enhancement is enough or not. This information is extracted through calculation of a set of metrics derived by weighted summations of AH through all luminance levels from 0 to 255. The weight functions (“WF”) can be of varies forms. A few of them are given here as examples. See FIG. 5 through FIG. 8

Varies Metrics (M₁, M₂, M₃, etc. . . . ) can be calculated by

$${M}_{1} = {\sum }_{i = 0}^{255} ( {WF}_{1} ( i ) \times AH ( i ) )$$

$${M}_{2} = {\sum }_{i = 0}^{255} ( {WF}_{2} ( i ) \times AH ( i ) )$$

$${M}_{3} = {\sum }_{i = 0}^{255} ( {WF}_{3} ( i ) \times AH ( i ) )$$

etc.

A set of thresholds has been empirically obtained by human inspections through a database of images and video clips with varying contents. These thresholds (Th₁, Th₂, Th₃, etc . . . ) are compared against metrics M₁, M₂, M₃, etc. A Decision Making Unit (“DMU”) is responsible to determine if the amount of enhancement is enough or not. DMU is essentially a set of rules that evaluates the truth table of comparisons of Metrics and Thresholds. The set of rules is empirically obtained through experiments and may depend on the characteristics of imaging sensors.

An example of decision rules used by the DMU is as follows:

If ((M₁>Th₁) And (M₂<Th₂) Then
a. Looping_Done=YES

ElseIf ((M₁>Th₁) And (M₃<Th₃) Then
a. Looping_Done=YES

ElseIf ((M₂>Th₂) And (M₁>Th₃) Then
a. Looping_Done=YES

ElseIf
a. Looping_Done=NO

The DMU gives a final answer of YES or NO depending upon the values of the metrics and the predefined thresholds. If the answer is YES, it means the desired amount of enhancement has been achieved and thus the loop is ended. The current MRC is used to remap each pixel's luminance level in the image or video frame into modified luminance level. The resulting image or video frame is properly enhanced. If the answer is NO, both parameters Q and Q1 need to be updated and the loop is going back and repeats again starting from VHE.

The Parameter Updating Unit (“PUU”) is responsible to find new values for Q and Q1. A simple updating rule will be increment the value of Q and decrement the value of Q1 by a preset delta. Please refer to Part II for the formula for computing Q and Q1 from a single parameter P. If the formula is used, then updating single parameter P is sufficient.

A more complex updating mechanism is used to predict the right increments of Q and decrements of Q1 in order to reduce the number of required iterations for achieving the desired amount enhancement. The updating rules are empirically obtained based on the differences of the paring Metrics and Thresholds. The rule of thumb is that if the differences are large, then increment the value of Q and decrement the value of Q1 by a larger amount of deltas, and vice-versa.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for calculating an enhanced image of a digital image wherein the digital image having a plurality of pixels each have a plurality of color components, comprising the steps of:
generating a histogram for each color components of a digital image;
summing the histograms to generate a combined histogram;
calculating a modified histogram as a function of a designated parameter;
generating a remapping curve as a function of the modified histogram by a cumulative distribution function; and
calculating enhanced pixels for an enhanced image.

2. The method of claim 1 wherein the combined histogram is normalized.

3. The method of claim 1 wherein in the calculating a modified histogram step, the function is a power function.

4. The method of claim 1 wherein the designated parameter is a fractional number between 0 and a designated constant.

5. The method of claim 3 wherein the designated parameter is a fractional number between 0 and a designated constant.

6. The method of claim 1 wherein the remapping curve, RC(j), is obtained by:
H(i)=(HR(i)+HG(i)+HB(i))×k, 0≦i≦255, k>0, for images (1)
and
H(i)=HY(i)×k, 0≦i≦255, k>0, for videos (1P)
where HR(i), HG(i) and HB(i) are histograms for red, green and blue color components (RGB), respectively, of pixels of an image, and HY(i) is the histogram of luminous Y component (of YCbCr) of pixels of a video frame, and k is a normalization constant; wherein
$$R C ( j ) = round ( p \times {\sum }_{i = 0}^{j} {H ( i )}^{Q} ) , 0 \leq j \leq 255 , 0 \leq Q \leq C , C > 0 \qquad ( 2 )$$
where p is a normalization factor.

7. The method of claim 1 wherein in the calculating enhanced pixels for an enhanced image step, for each pixel p in an image, let pr, pg and pb represent red, green and blue components of the pixel, let the maximum of the three component be denoted by l=max(pr, pg, pb), calculate the enhanced pixel p′ whose 3 components p′r, p′g and p′b are obtained by the following equations:
l′=RC(l)
$$f = \frac{{l}^{′}}{l}$$
p′r=a₁×f×pr
p′g=a₂×f×pg
p′b=a₃×f×pb
where a₁, a₂, a₃ are proportional coefficients.

8. The method of claim 1 wherein in the calculating enhanced pixels for an enhanced image step, for each pixel p in an image, let pr, pg and pb represent red, green and blue components of the pixel, let the maximum of the three component be denoted by l=max(pr, pg, pb), calculate the enhanced pixel p′ whose 3 components p′r, p′g and p′b are obtained by the following equations:
$$f = \frac{R C ( p y )}{p y}$$
p′y=a₁×RC(py)
p′u=a₂×f×pu
p′v=a₃×f×pv
where a₁, a₂, a₃ are proportional coefficients.

9. The method of claim 1 wherein an additional step for adjusting color saturation is added.

10. The method of claim 9 wherein the adjusting color saturation step comprises:
l′=RC(l)
$$f = \frac{{l}^{′}}{l}$$
p′r=a×f×pr+(1−a)×RC(pr)
p′g=a×f×pg+(1−a)×RC(pg)
p′b=a×f×pb+(1−a)×RC(pb)
where the parameter a is a color saturation adjustment parameter.

11. The method of claim 9 wherein the adjusting color saturation step for videos comprises:
$$f = \frac{R C ( p y )}{p y}$$
p′y=RC(py)
p′u=(a×f+1−a)×pu
p′v=(a×f+1−a)×pv
where the parameter a is a color saturation adjustment parameter.

12. The method of claim 1 wherein, for video sequences, for each pixel p in a video frame, wherein py, pu and pv represent luma (Y), chroma Cb and Cr components of a pixel, and wherein the enhanced pixel p′ whose components p′y, p′u and p′v are obtained by the following equations:
p′y=a₁×RC(py)
p′u=a₂×pu
p′v=a₃×pv
where a₁, a₂, a₃ are proportional coefficients.

13. A method for calculating an enhanced image of a digital image wherein the digital image having a plurality of pixels each have a plurality of color components, comprising the steps of:
generating a histogram for each color components of a digital image;
summing the histograms to generate a combined histogram;
calculating a modified histogram as a power function of a designated parameter, wherein the designated parameter is a fractional number between 0 and a designated constant;
generating a remapping curve as a function of the modified histogram by a cumulative distribution function; and
calculating enhanced pixels for an enhanced image;
wherein the remapping curve, RC(j), is obtained by:
H(i)=(HR(i)+HG(i)+HB(i))×k, 0≦i≦255, k>0, for images
and
H(i)=HY(i)×k, 0≦i≦255, k>0, for videos
where HR(i), HG(i) and HB(i) are histograms for red, green and blue color components (RGB), respectively, of pixels of an image, and HY(i) is the histogram of luminous component (YCbCr) of pixels of a video frame, and k is a normalization constant; wherein
$$R C ( j ) = round ( p \times {\sum }_{i = 0}^{j} {H ( i )}^{Q} ) ,$$
0≦j≦255, 0≦Q≦C, C>0 (2)
where p is a normalization factor.

14. The method of claim 13 wherein the combined histogram is normalized.

15. The method of claim 13 wherein in the calculating enhanced pixels for an enhanced image step, for each pixel p in an image, let pr, pg and pb represent red, green and blue components of the pixel, let the maximum of the three component be denoted by l=max(pr, pg, pb), calculate the enhanced pixel p′ whose 3 components p′r, p′g and p′b are obtained by the following equations:
l′=RC(l)
$$f = \frac{{l}^{′}}{l}$$
p′r=a₁×f×pr
p′g=a₂×f×pg
p′b=a₃×f×pb
where a₁, a₂, a₃ are proportional coefficients.

16. The method of claim 13 wherein in the calculating enhanced pixels for an enhanced image step, for each pixel p in an image, let pr, pg and pb represent red, green and blue components of the pixel, let the maximum of the three component be denoted by l=max(pr, pg, pb), calculate the enhanced pixel p′ whose 3 components p′r, p′g and p′b are obtained by the following equations:
$$f = \frac{R C ( p y )}{p y}$$
p′y=a₁×RC(py)
p′u=a₂×f×pu
p′v=a₃×f×pv
where a₁, a₂, a₃ are proportional coefficients.

17. The method of claim 13 wherein an additional step for adjusting color saturation is added.

18. The method of claim 18 wherein the adjusting color saturation step comprises:
l′=RC(l)
$$f = \frac{{l}^{′}}{l}$$
p′r=a×f×pr+(1−a)×RC(pr)
p′g=a×f×pg+(1−a)×RC(pg)
p′b=a×f×pb+(1−a)×RC(pb)
where the parameter a is a color saturation adjustment parameter.

19. The method of claim 17 wherein the adjusting color saturation step for videos comprises:
$$f = \frac{R C ( p y )}{p y}$$
p′y=RC(py)
p′u=(a×f+1−a)×pu
p′v=(a×f+1−a)×pv
where the parameter a is a color saturation adjustment parameter.

20. The method of claim 13 wherein, for video images, for each pixel p in a video frame, wherein py, pu and pv represent luma (Y), chroma Cb and Cr components of a pixel, and wherein the enhanced pixel p′ whose components p′y, p′u and p′v are obtained by the following equations:
p′y=a₁×RC(py)
p′u=a₂×pu
p′v=a₃×pv
where a₁, a₂, a₃ are proportional coefficients.
